(19) United States
(12) Patent Application Publication
(10) Pub. No.: US 2015/0188157 A1
(43) Pub. Date: Jul. 2, 2015

(54) 3-WAY VALVE FOR FUEL CELL VEHICLE

(71) Applicants: Hyundai Motor Company, Seoul (KR); Kia Motors Corporation, Seoul (KR)

(72) Inventors: Sung Wook NA, Yongin-si (KR); Chi Myung KIM, Yongin-si (KR); Hun Woo PARK, Namyangju-si (KR)

(21) Appl. No.: 14/566,322

(22) Filed: Dec. 10, 2014

(30) Foreign Application Priority Data
Dec. 30, 2013 (KR) 10-2013-0167261

(51) Int. Cl. H01M 8/04; F16K 5/04; F16K 11/085

(52) U.S. Cl. CPC H01M 8/04029; F16K 11/0853; F16K 5/0471

(57) ABSTRACT

A 3-way valve for a fuel cell vehicle includes a valve housing having stack, bypass port, and radiator ports. A flow control valve is disposed in the valve housing and selectively opens/closes the stack, bypass, or radiator ports by means of a motor. Gaskets preventing a leakage are in contact with an outer side of the flow control valve and are disposed on circumferential surfaces around the edges of inlets of the stack, bypass, and radiator ports of the valve housing.

### CROSS-REFERENCE TO RELATED APPLICATION

This application claims under 35 U.S.C. §119(a) the benefit of Korean Patent Application 10-2013-0167261 filed Dec. 30, 2013, the entire contents of which are incorporated herein by reference.

### TECHNICAL FIELD

The present disclosure relates to a 3-way valve for a fuel cell vehicle, and more particularly, to a 3-way valve for controlling a temperature of a coolant to flow into a fuel cell stack at the optimum level in order to maintain a stable operation of the fuel cell stack.

### BACKGROUND

In general, fuel cell stacks, which are main power suppliers in fuel cell vehicles, generate power from oxygen of the air and hydrogen that is fuel.

Since the fuel cell stacks can stably produce the optimum output when a coolant at the optimum temperature flows in the stacks, it is very important to maintain the coolant, which flows into the stacks, at the optimum temperature.

In general, the fuel cell stacks generate a small amount of heat in the initial start of fuel cell systems, the coolant flows along a loop of; stack→pump→3-way valve→stack, when its temperature is low.

Further, when the amount of heat generated by the stacks increases, and the temperature of the coolant increases after a period of time, the 3-way valve appropriately blocks a bypass loop, such that the coolant flows along a loop of; stack→pump→radiator→3-way valve→stack.

The temperature of the coolant at the inlet of a stack in fuel cell vehicles needs to be about 65° C., such that, a 3-way valve appropriately controls the amount of opening of both loops in response to a signal of the inlet temperature of the stack and allows the coolant to flow into the stack at a constant temperature regardless of the external environment.

Generally, in electronic 3-way valves for fuel cell vehicles, a flow control valve controls a system operation temperature (temperature of a coolant flowing into an inlet of a stack) by mixing cold water from a radiator with hot water flowing to a bypass while rotating.

For example, as shown in FIG. 5, the operation temperature is controlled with an opening ratio of 0% at a radiator (a), the opening ratio of 45% at a radiator (b), and the opening ratio of 100% at a radiator (c), etc.

The reference numerals ‘10’ and ‘11’ not stated above indicate a flow control valve and a valve housing.

Controlling the system operation temperature plays a crucial role in a heat and water management system because it is directly connected with the output efficiency of fuel cell stacks. The 3-way valves can accurately control the system operation temperature, only when there is no port leakage.

The flow control valves of the existing 3-way valves are primarily manufactured by die casting, precise machining is additionally performed on a valve surface, a valve housing is also manufactured by die casting, and then precise machining is additionally performed on an inner side of the housing (side to come in contact with an outer side of the valve).

Three-dimensional precise measuring is performed on the flow control valves and the valve housing manufactured as described above, and a 3-way valve is completed by assembling them.

For example, in order to manufacture ten 3-way valves, ten housings and ten flow control valves are manufactured, three-dimensional measuring is performed, and they are assembled with a tolerance of 0.065 or less.

However, as shown in FIG. 6, it is impossible to completely prevent port leakage because the flow control valve 10 in the 3-way valve has to rotate, and the current manufacturing technologies cannot produce such a precise machining for mass production for the fuel cell vehicles, thus reducing the machining quality and increasing the manufacturing cost.

Accordingly, the following adverse influences on vehicles are caused by the port leakage at a radiator in winter.

First, a possible normal operation time is delayed by interference with a temperature increase of a coolant after an engine starts.

Second, in operation with a low output (e.g., city driving mode in winter), a system operation temperature is continuously dropped by the port leakage at a radiator, and accordingly, fuel efficiency is reduced.

In consideration of those matters, a flow control valve that prevents a coolant from leaking outside with a sealing member between an opening and a connection hole of a valve body has been proposed in Japanese Patent Publication No. 2005-048935. However, the sealing member is inserted in a groove inside a port, such that not only it is disadvantageous in convenience of manufacturing and assembling, but also it is difficult to contact with the outer surface of the valve, and thus, the effect of preventing leakage is low.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a 3-way valve for a fuel cell vehicle which can ensure accuracy of controlling coolant temperature and improve output efficiency of a fuel cell stack. The 3-way valve has a new type of anti-port leakage structure that can minimize a port leakage, using a gasket, which is disposed at a protrusion of a port inlet of a valve housing, to be in contact with a flow control valve.

The 3-way valve for a fuel cell vehicle includes a valve housing having a stack port, a bypass port, and a radiator port. A flow control valve is disposed in the valve housing and selectively opens/closes the stack, bypass, or radiator ports by means of a motor. Gaskets, which prevent a leakage, are in contact with an outer side of the flow control valve and are disposed on surfaces of protrusions around the inlets of the stack port, the bypass port, and the radiator port of the valve housing.

The gaskets may be disposed around the entire edges of the protrusions of the inlets of the stack, bypass, and radiator ports, having widths equal to or less than widths of the ports. The gaskets may be made of an ethylene propylene diene monomer (EPDM) material that is ethylene propylene rubber.

The 3-way valve for a fuel cell vehicle provided by the present disclosure has the following advantages:

First, since the gaskets for preventing leakage is attached to the surfaces of the protrusions around the inlets of the ports of the valve housing, it is possible to minimize the leakage due to a gap. Accordingly, the accuracy in control of coolant temperature of the 3-way valve is increased, thus securing the optimum output efficiency of a fuel cell stack.

Second, after an engine starts, the time taken to increase in temperature can be reduced.

Third, the leakage at the radiator port in low-power driving (city mode in wither) can be prevented.

Fourth, since the gaskets are attached at the protrusions of the inlets of the ports, the convenience of manufacturing is improved, and it is possible to contact with the outer side of the valve, such that airtightness can be increased.

Fifths, since the gaskets are attached at the protrusions of the inlets of the ports, efficiency of electric power used for driving of the flow control valve can be improved by minimizing a contact area with the flow control valve in the interior of the housing.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention.

FIG. 1 is a perspective view showing the entire configuration of a 3-way valve for a fuel cell vehicle according to an embodiment of the present disclosure.

FIG. 2 is a perspective view and a picture showing the 3-way valve for a fuel cell vehicle according to an embodiment of the present disclosure.

FIG. 3 is a plan view and an enlarged view showing the 3-way valve for a fuel cell vehicle according to an embodiment of the present disclosure.

FIG. 4 is a graph showing changes in coolant temperature due to a gap tolerance when the 3-way valve for a fuel cell vehicle according to the embodiment of the present disclosure is applied.

FIG. 5 is a plan view showing a 3-way valve for a fuel cell vehicle of the related art.

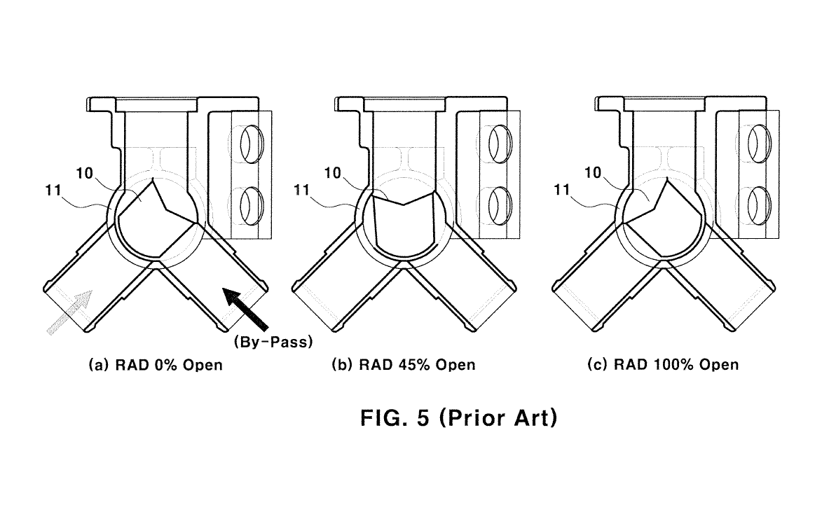

FIG. 6 is a plan view showing a gap tolerance in the 3-way valve for a fuel cell vehicle of the related art.

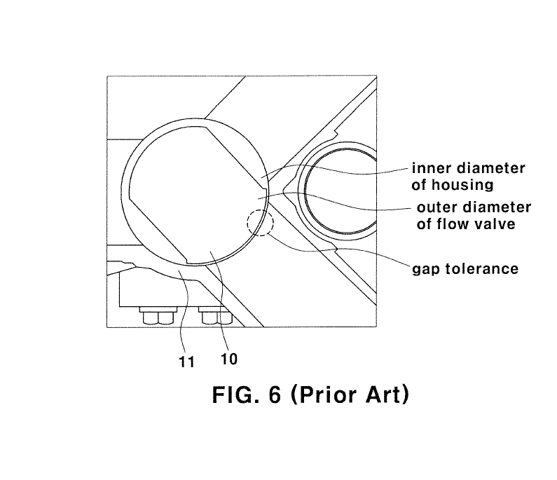

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

### Examples

Hereinafter, the present disclosure is described in detail with reference to the accompanying drawings.

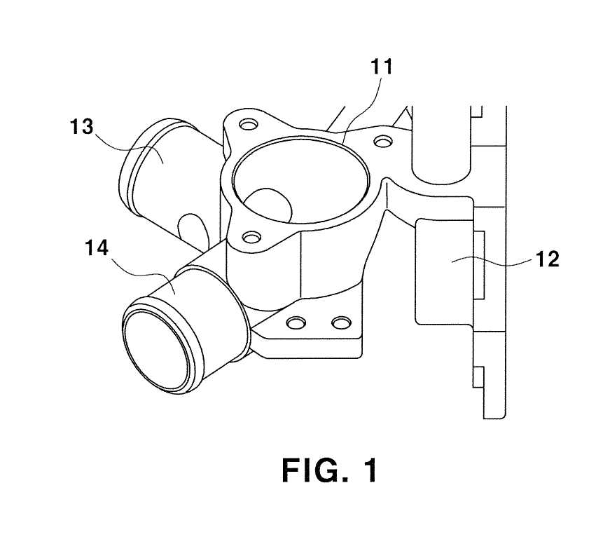

FIG. 1 is a perspective view showing the entire configuration of a 3-way valve for a fuel cell vehicle according to an embodiment of the present disclosure.

As shown in FIG. 1, the 3-way valve includes a valve housing 11 with stack, bypass, and radiator ports 12, 13, and 14 connected to a stack, a pump, and a radiator, respectively. A flow control valve (not shown) is disposed in the valve housing 11 and selectively opens/closes the ports 12, 13, and 14. An actuator (not shown) is disposed in an actuator housing (not shown) at a side of the flow control valve and operates the flow control valve. A controller (not shown) controls the actuator.

The way of operating the flow control valve, using the power from the actuator controlled by the controller is the same as that of the related art, and thus, the detailed description is not provided.

The flow control valve is disposed in the valve housing 11 and can selectively open/close the ports while rotating and being in contact with inlets of the stack port 12, the bypass port 13, and the radiator port 14.

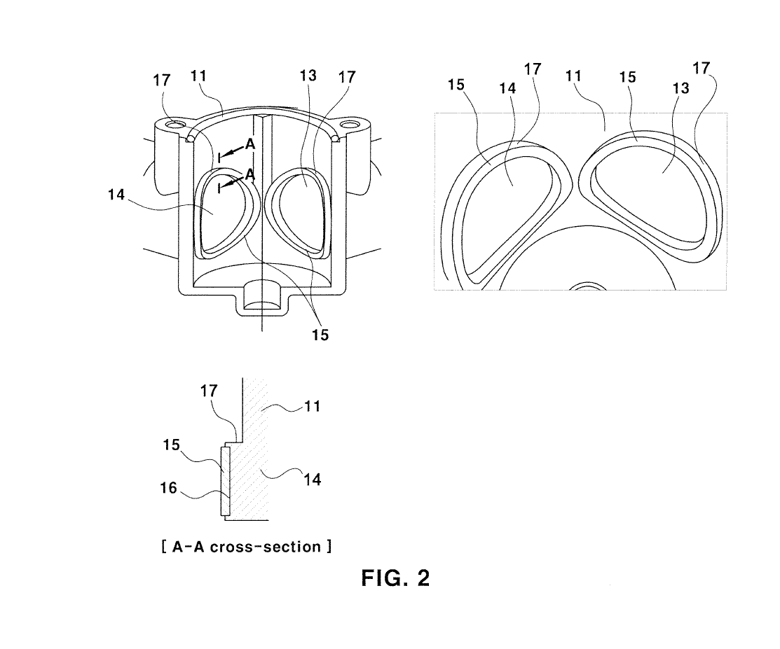

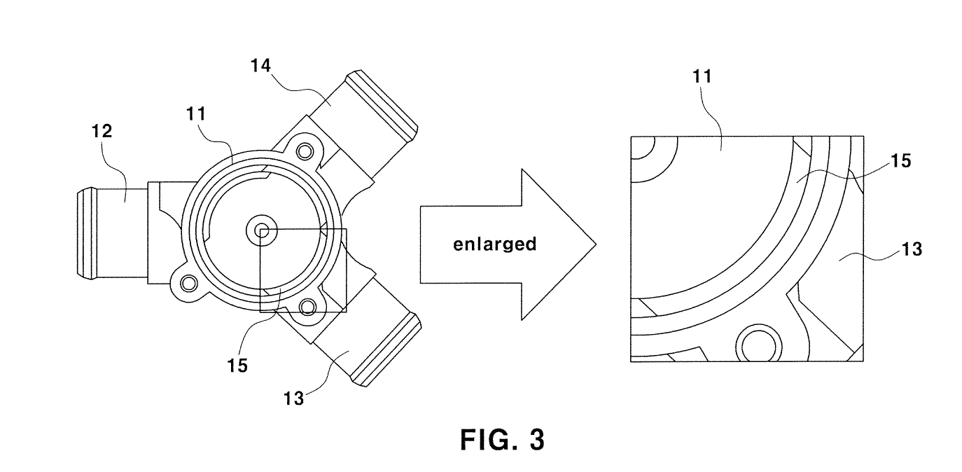

FIG. 2 is a perspective view showing the 3-way valve for a fuel cell vehicle according to an embodiment of the present disclosure, and FIG. 3 is a plan view and an enlarged view showing the 3-way valve for a fuel cell vehicle according to an embodiment of the present disclosure.

As shown in FIGS. 2 and 3, the 3-way valve has a structure that can compensate a gap tolerance with gasket structures at the inlet of the ports, and accordingly, it can secure accuracy in control of coolant temperature by minimizing a port leakage.

The valve housing 11 with the stack port 12, the bypass port 13, and the radiator port 14 are provided and the flow control valve (not shown) coming in contact with the inlets of the ports is disposed in the valve housing 11, such that the ports can be selectively opened/closed.

Protrusions 17 having a predetermined height in a direction in which the protrusions 17 contact the flow control valve are provided on surfaces of the inlets of the stack port 12, the bypass port 13, and the radiator port 14, and a gasket 15 for preventing the leakage is disposed on surfaces that an outer side of the flow control valve comes in contact with. That is, the gasket 15 is located on the protrusions disposed in the interior of the housing.

The gaskets 15 can maintain the airtightness around the inlets of the ports by being pressed when in contact with the outer side of the flow control valve 10, such that the gaskets 15 prevent the leakage at the inlets of the ports.

The gaskets 15 may have widths equal to or less than widths of the protrusions 17 located at the inlets of stack port 12, the bypass port 13, and the radiator port 14, and may be disposed around the entire inlets of the ports 12, 13, and 14.

In this way, since the gaskets 15 are installed on the protrusions 17, a contact area between the flow control valve (not shown) for rotation in the interior of the housing and the gaskets 15 can be minimized.

That is, the gaskets 15 having a width equal to or less than widths of the protrusions may be provided on the protrusions 17, and the contact area between the flow control valve (not shown) and the gaskets 17 is equal to or smaller than a contact area of surfaces of the protrusions 17 contacting the flow control valve.

For example, the gasket 15 may be formed in a ring shape that is disposed to fit the protrusions 17 of the inlet of a circular shaped port.

The gaskets 15 may be fitted in gasket grooves 16, respectively, which are formed on surfaces of the protrusions 17 around the inlets of the stack port 12, the bypass port 13, and the radiator port 14. The gasket grooves 16 are continuously formed on the surfaces of the protrusions 17 around the entire inlets of the ports.

Since the outer side of the flow control valve 10 and the inlets of the ports are usually in close contact, the gaskets 15 in the gasket grooves 16 can also be pressed by the outer side of the flow control valve 10, and as a result, they can maintain a stable position.

The gaskets 15 may be made of various materials, for example, an EPDM material that is ethylene propylene rubber that allows for high airtightness even under cold-starting of an engine at −35° C.

A coating layer may be formed with teflon on the surface of the gaskets 15 in order to reduce a friction coefficient when contacting a rotary body.

Accordingly, the flow control valve, which selectively opens/closes the ports 12, 13, and 14 which are connected to the stack, the pump, and the radiator when a fuel cell stack operates, is in contact with the protrusions 17 of the inlets of the ports 12, 13, and 14 in the valve housing 11, substantially in close contact with the gaskets 15 around the protrusions 17 of the inlets of the ports 12, 13, and 14, and the inlets of the ports 12, 13, and 14 can maintain the airtightness by the gaskets 15 around the inlets of the ports 12, 13, and 14.

Therefore, the airtightness can be improved by the gaskets 15 being pressed between an outlet of the flow control valve 10 and the protrusions of the inlets of the ports 12, 13, and 14, thus minimizing the leakage at the ports 12, 13, and 14.

The following Table 1 shows a test result of leakage amount estimation on the 3-way valve of the present disclosure having gaskets and an existing 3-way valve.

TABLE 1

| | 3-way valve | 3-way valve | |
|---|---|---|---|
| | (without gasket) | (with gasket) | effect |
| leakage amount | 90 cc/min | 50 cc/min | about 45% reduced |

As shown in the result in Table 1, it can be seen that the leakage amount in the 3-way valve of the present disclosure equipped with gaskets has a leakage reduction effect of about 45%, as compared with the existing 3-way valve.

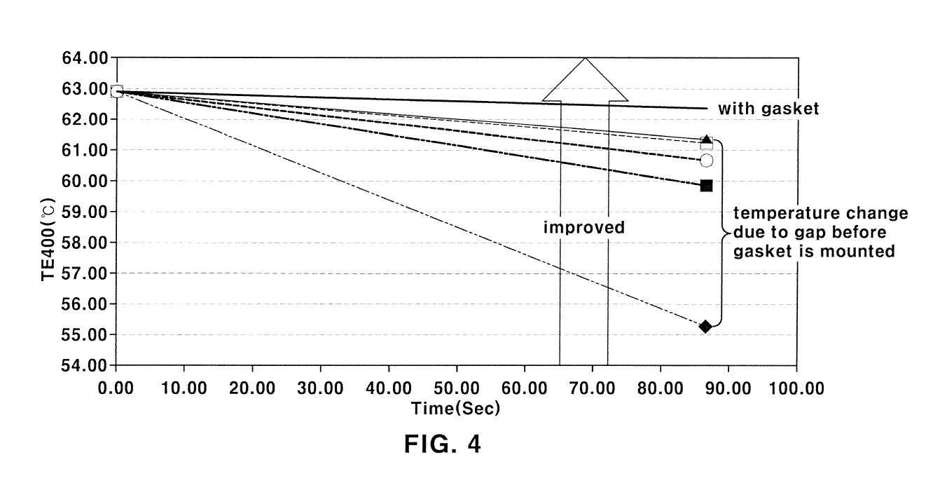

Further, as shown in the graph of FIG. 4, as the result of measuring changes in a coolant temperature due to gap tolerances, it can be seen that it takes a shorter time to increase the coolant temperature after an engine is started, which allows reduction of the possible normal operation time.

As described above, since a leakage due to gaps is improved by gaskets for preventing leakage at the ports of a 3-way valve in the present disclosure, it is possible to increase accuracy in control of coolant temperature in the 3-way valve and to reduce the possible normal operation time by reducing the time that the coolant takes to increase in temperature after an engine is started. Further, it is possible to improve fuel efficiency in low-power driving by improving leakage at the radiator port in low-power driving such as a city driving mode in winter.

In addition, Table 2 shows a current consumed when a flow control valve corresponding to a 3-way valve according to the related art is driven and a current consumed when a flow control valve of a 3-way valve including the gaskets 15 located on the protrusions 17 according to the present invention is driven.

TABLE 2

| | Present technology | | Comparative | |
|---|---|---|---|---|
| | (Embodiment) | | Example | |
| Contact area of seal gasket | 87 | mm2 | 148 | mm2 |
| Consumption current of motor | 0.8 | A | 1.4 | A |
| Outer diameter of seal gasket | 38.1 | mm | 38.1 | mm |

It can be seen from the embodiment that when a contact area between the seal gasket and the flow control valve increases from 87 mm2 to 148 mm2, the consumption current increases from 0.8 A to 1.4 A.

Considering that the 3-way valve is an essential element in an aspect of heat transfer and cooling, it can be seen that when a contact area between the flow control valve and the gasket increases 1.7 times, a consumption current increases 1.75 times, and a significant effect different exists in an aspect of an overall efficiency of the system of the fuel cell vehicle.

That is, the present invention includes the protrusions 17 to minimize a contact area between the flow control valve located in the interior of the housing and the gaskets 15. Accordingly, when the flow control valve is driven, a contact area between the gaskets 15 and the flow control valve decreases and accordingly, a power consumption of the driving motor decreases. That is, overall fuel ratio can be improved.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A 3-way valve for a fuel cell vehicle comprising:
a valve housing to which a stack port, a bypass port, and a radiator port are connected; and
a flow control valve disposed in the valve housing and selectively opening/closing the stack, bypass, or radiator ports by means of a motor,
wherein protrusions are provided at inlets of the stack, bypass, and radiator ports of the valve housing, and gaskets preventing a leakage are in contact with an outer side of the flow control valve are installed on surfaces of the protrusions.

2. The 3-way valve of claim 1, wherein the gaskets are disposed around the entire edges of inlets of the stack, bypass, and radiator ports, the gaskets having widths equal to or less than widths of the protrusions located at the inlets of the stack, bypass, and radiator ports.

3. The 3-way valve of claim 1, wherein the gaskets are fitted in gasket grooves formed on the surfaces of the protrusions at the inlets of the stack, bypass, and radiator ports.

4. The 3-way valve of claim 1, wherein the gaskets are made of an ethylene propylene diene monomer (EPDM) material that is ethylene propylene rubber.

5. The 3-way valve of claim 1, wherein the circumferential surfaces of the gaskets are coated with Teflon® to reduce a friction coefficient.

6. The 3-way valve of claim 2, wherein the gaskets are made of an EPDM material that is ethylene propylene rubber.

7. The 3-way valve of claim 3, wherein the gaskets are made of an EPDM material that is ethylene propylene rubber.

8. The 3-way valve of claim 2, wherein the surfaces of the gaskets are coated with Teflon® to reduce a friction coefficient.

9. The 3-way valve of claim 3, wherein the surfaces of the gaskets are coated with Teflon® to reduce a friction coefficient.

10. The 3-way valve of claim 1, wherein the gasket are formed in a ring shape that is disposed to fit the edges of inlets of the stack, bypass, and radiator ports which have a circular shape.
